(19) United States
(12) Patent Application Publication
(10) Pub. No.: US 2025/0061516 A1
(43) Pub. Date: Feb. 20, 2025

(54) PREDICTING RECURRENCE FROM FINANCIAL DATA

(71) Applicant: Yodlee, Inc., Raleigh, NC (US)

(72) Inventors: Ambar Bandyopadhyay, Kolkata (IN); Om D. Deshmukh, Bangalore (IN); Vinay Manjunath, Bangalore (IN); Deepak Patil, Bangalore (IN); Rushikesh Rathod, Mumbai (IN)

(21) Appl. No.: 18/235,264

(22) Filed: Aug. 17, 2023

(51) Int. Cl. G06Q 40/06

(52) U.S. Cl. CPC G06Q 40/06

(57) ABSTRACT

As described herein, a system, method, and computer program are provided for predicting recurrence from financial data. Financial transaction data is accessed for an individual. The financial transaction data is processed to detect one or more recurring financial transactions, wherein each of the recurring financial transactions is detected based on contextual information included in the financial transaction data. The one or more recurring financial transactions are output.

### FIELD OF THE INVENTION

The present invention relates to processing financial data to manage financial wellness.

### BACKGROUND

Recurring financial transactions refer to the payments that are made, whether to an individual/entity (i.e. income) or by an individual/entity (i.e. expenses), on a regular basis, typically at predetermined intervals. These transactions can include anything from monthly rent payments to regular subscription fees for a service, as well as regular income deposits. In financial wellness, knowing the recurrence of income and expenses is crucial for effective budgeting and financial planning. Understanding how often income is received and expenses are incurred can help individuals and households better manage their cash flow and make informed decisions about their finances.

For example, knowing the recurrence of income can help individuals and households plan for regular expenses, such as rent or mortgage payments, utilities, and other bills. It can also help them anticipate irregular expenses, such as car repairs or medical bills, and ensure they have enough money set aside to cover these costs. Overall, understanding the recurrence of income and expenses is essential for financial wellness and can help individuals and households make informed decisions about their finances, reduce financial stress, and achieve their long-term financial goals.

However, examining individual transactions in isolation in order to determine whether they are recurring, or non-recurring may not be very useful due to the fact that this determination is dependent on an individual's behavior. What may be considered a recurring transaction for one individual may be classified as non-recurring for another individual, based on their unique circumstances. For instance, an individual with a stable job would receive their salary at fixed intervals, while gig workers may also receive payment, but not at predetermined intervals. The income in the first case is “regular income” whereas in the other case it is “irregular income”.

There is thus a need for addressing these and/or other issues associated with the prior art. For example, there is a need to predict recurrence from financial data in a manner that considers the context of the financial data.

### SUMMARY

As described herein, a system, method, and computer program are provided for predicting recurrence from financial data. Financial transaction data is accessed for an individual. The financial transaction data is processed to detect one or more recurring financial transactions, wherein each of the recurring financial transactions is detected based on contextual information included in the financial transaction data. The one or more recurring financial transactions are output.

### BRIEF DESCRIPTION OF THE DRAWINGS

FIG. 1 illustrates a method for predicting recurrence from financial data, in accordance with one embodiment.

FIG. 2 illustrates a system for predicting recurrence from financial data, in accordance with one embodiment.

FIG. 3 illustrates block diagram of the software components of the recurrence predictor of FIG. 2, in accordance with one embodiment.

FIG. 4 illustrates a network architecture, in accordance with one possible embodiment.

FIG. 5 illustrates an exemplary system, in accordance with one embodiment.

### DETAILED DESCRIPTION

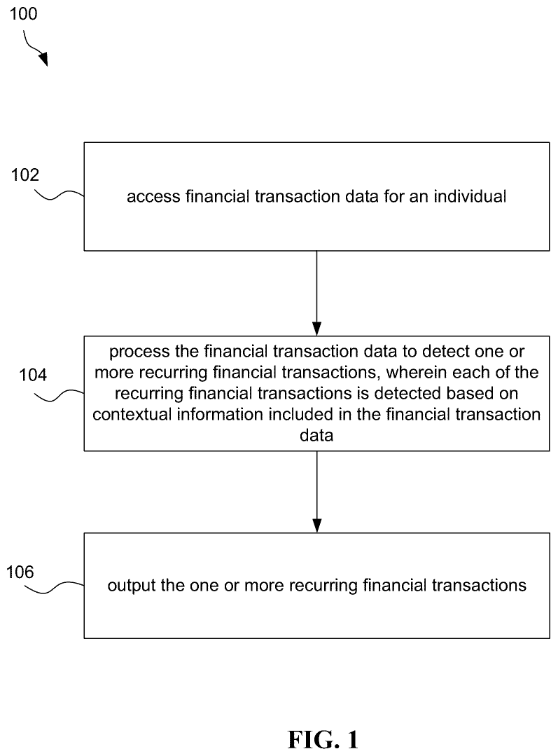

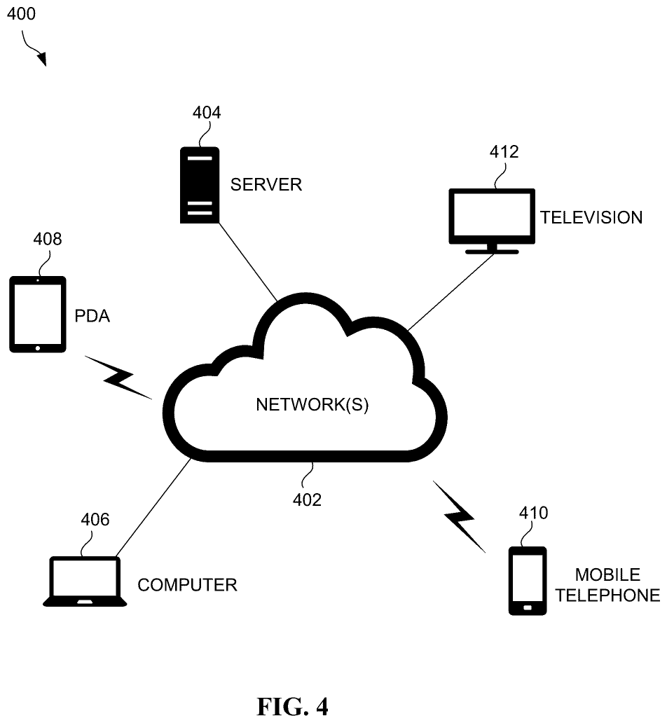

FIG. 1 illustrates a method 100 for predicting recurrence from financial data, in accordance with one embodiment. The method 100 may be performed by any computer system, such as those described below with respect to FIGS. 4 and/or 5. For example, in one embodiment, the method 100 may be performed by a computer system interfacing a system of one or more financial institutions that generate financial transaction data based on the financial transactions of its customers (e.g. users, business entities, etc.), among other data systems. The computer system performing the method 100 may be a sub-system of one of the financial institutions, in another embodiment.

The method 100 is performed to predict recurring financial transactions for an individual, from the individual's financial transaction data. The recurring financial transactions may in turn be used for various purposes, such as financial account management. In the context of the present description, a “financial institution” refers to any entity that facilitates financial transactions for its customers, such as a banking entity. A financial transaction may be a monetary deposit, monetary withdrawal, monetary transfer, or any other transaction involving money.

In operation 102, financial transaction data is accessed for an individual. The individual is any person or entity (e.g. business entity) for which financial transactions have been performed by one or more financial institutions. Accordingly, the individual may be a customer of one or more financial institutions (e.g. may have an account with the financial institution(s)).

With respect to the present description, the financial transaction data is data associated with (e.g. recording, defining, etc.) prior financial transactions of the individual. In particular, the financial transaction data may include historical financial transactions performed using at least one account of the individual with at least one financial institution. For example, the historical financial transactions may include withdrawals from the at least one account and deposits to the at least one account. Each financial transaction may be represented by values for various dimensions, such as values for transaction type (e.g. withdrawal, deposit), transaction category (e.g. entertainment, utilities), monetary amount, merchant, etc.

The financial transaction data may be accessed from the financial institution(s), in an embodiment. The historical financial transactions included in the financial transaction data may include those that occurred over a defined period of time. The defined period of time may be represented using a start date and an end date, for example.

In operation 104, the financial transaction data is processed to detect one or more recurring financial transactions, wherein each of the recurring financial transactions is detected based on contextual information included in the financial transaction data. With respect to the present description, a recurring financial transaction refers to a financial transaction that has repeated with some particular periodicity. The recurring financial transaction may repeat with exact same values for one or more dimensions of the financial transaction, or with values having a threshold level of similarity for one or more such dimensions. The recurring financial transactions may include a recurring withdrawal from the at least one account and/or a recurring deposit to the at least one account.

As mentioned, the recurring financial transactions are detected based on contextual information included in the financial transaction data. The contextual information may be defined in one or more dimensions of each financial transaction included in the financial transaction data, and may include for example transaction category, merchant, etc. By detecting the recurring financial transactions based on the contextual information, the detection may be tailored to the financial transactions of the individual (and in turn the financial transactional behavior of the individual).

There are various processes that may be configured to detect recurring financial transactions based on contextual information included in the financial transaction data. In an embodiment, the financial transaction data may be processed by normalizing each historical financial transaction included in the financial transaction data. Normalizing each historical financial transaction may include reducing a dimensionality of the historical financial transaction.

In an embodiment, the financial transaction data may be processed by quantifying a similarity between every unique pair of normalized historical financial transactions. In an embodiment, the financial transaction data may be processed by creating a graph based on the similarity between every unique pair of normalized historical financial transactions. With respect to this embodiment, the normalized historical financial transactions may be represented as nodes in the graph, where an edge is created between nodes representing one of the unique pairs of normalized historical financial transactions when the similarity between the unique pair of normalized historical financial transactions is greater or equal to a predefined threshold.

In an embodiment, the financial transaction data may be processed by identifying each set of connected nodes in the graph as a respective series. In an embodiment, the financial transaction data may be processed by partitioning each series hierarchically by dimension. In an embodiment, the financial transaction data may be processed by computing a probabilistic periodicity value at each hierarchical level for each series, where the periodicity is selected from: weekly, biweekly, monthly, quarterly, half-yearly, no-periodicity, and/or any combination of the same.

In an embodiment, the financial transaction data may be processed by optimizing a periodicity score per series based on the probabilistic periodicity value at each hierarchical level for the series, determining one series with a highest periodicity score, designating the one series as a final series, and assigning an identifier of the final series and a periodicity of the final series to transactions associated with the final series, such that the transactions associated with the final series are detected as at least a portion of the one or more recurring financial transactions. With respect to this embodiment, the periodicity score may be optimized utilizing a tree-based information gain system, where a tree is constructed and post-order traversal is employed to optimize the periodicity score based on the probabilistic periodicity value at each hierarchical level for the series.

In operation 106, one or more recurring financial transactions are output. In an embodiment, the one or more recurring financial transactions may be output for forecasting future income and expenses for the individual. In another embodiment, the one or more recurring financial transactions may be output in a report. Of course, however, the one or more recurring financial transactions that have been detected from the financial transaction data of the individual may be output for any desired purpose relating to financial management.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

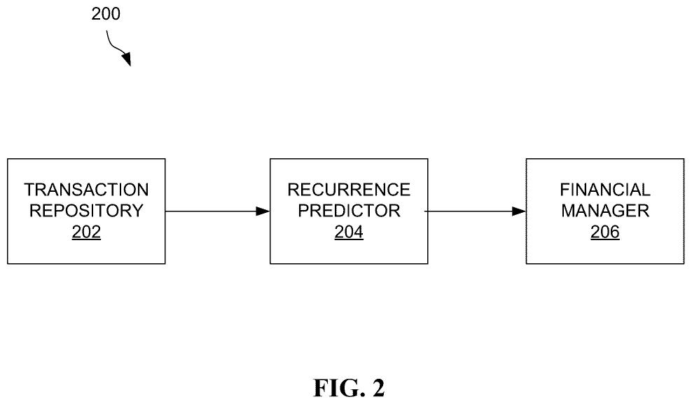

FIG. 2 illustrates a system 200 for predicting recurrence from financial data, in accordance with one embodiment. As an option, the system 200 may be implemented in the context of the details of the previous figure and/or any subsequent figure(s). For example, the system 200, or any components thereof, may interface a system of one or more financial institutions that generate financial transaction data based on the financial transactions of its customers. As another example, the system 200, or any components thereof, may be a sub-system of one of the financial institutions. Of course, however, the system 200 may be implemented in the context of any desired environment. Further, the aforementioned definitions may equally apply to the description below.

As shown, the system 200 includes (or interfaces) a transaction repository 202. The transaction repository 202 stores the historical financial transactions of individuals generated by one or more financial institutions. While only one transaction repository 202 is shown, the system 200 may likewise include (or interface) multiple transaction repositories of different financial institutions.

The system 200 also includes a recurrence predictor 204. The recurrence predictor 204 is a computer process configured to access financial transaction data for an individual from the transaction repository 202 and to process the financial transaction data to detect recurring financial transaction(s) based on contextual information included in the financial transaction data. The recurrence predictor 204 is further configured to output the detected recurring financial transaction(s) to a financial manager 206.

The financial manager 206 is a component of the system 206 that is configured to use the recurring financial transaction(s) of an individual for some defined purpose. In an embodiment, the financial manager 206 may include an interface through which an indication of the recurring financial transaction(s) can be reported. In possible embodiments, the recurring financial transaction(s) may be reported to the individual for use in understanding their recurring withdrawals (expenses) and/or deposits (income), or the recurring financial transaction(s) may be reported to a product development team for use in creating a financial product that is based on those recurring financial transaction(s).

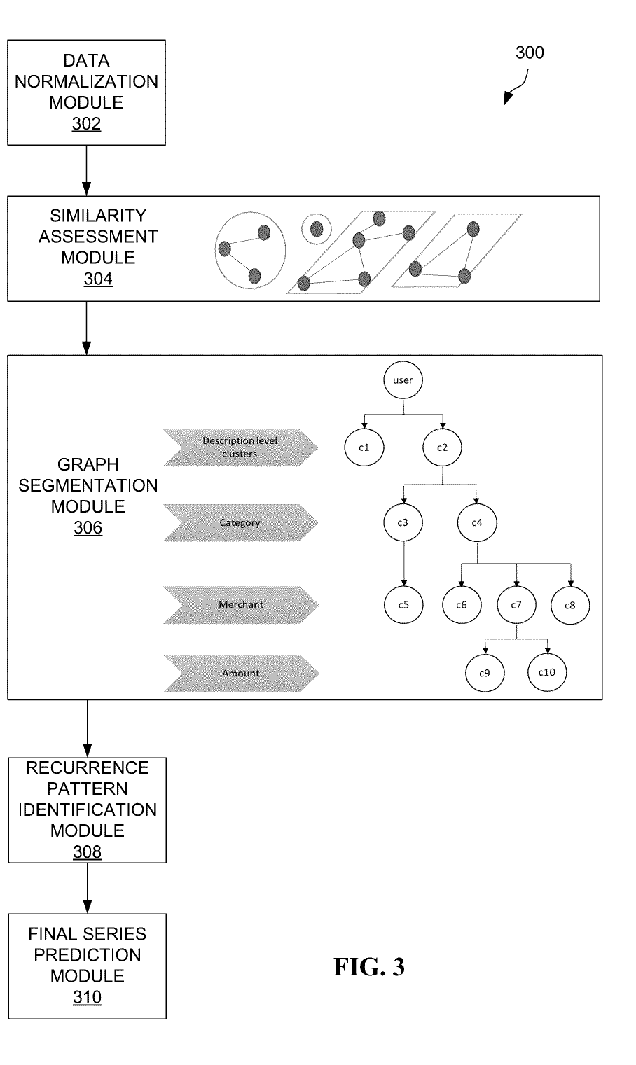

FIG. 3 illustrates block diagram of the software components 300 of the recurrence predictor 204 of FIG. 2, in accordance with one embodiment. It should be noted that these software components 300 are set forth for illustrative purposes only and should only be construed as illustrating one possible implementation of the recurrence predictor 204 of FIG. 2. Again, the aforementioned definitions may equally apply to the description below.

The software components 300 include the following five individual modules that operate sequentially:

Data Normalization module 302: Normalize each transaction to standardize subsequent processing, reduce dimensionality, and enhance efficiency and accuracy.

Similarity Assessment module 304: Quantifying similarity between every unique pair of Normalized transactions.

Graph Segmentation module 306: Creating a graph that has transactions as the nodes and the similarity of each pair of the nodes as the corresponding edge. Identifying all connected components, which will serve as individual segment/cluster.

Recurrence Pattern Identification module 308: For each segment/cluster identify a probabilistic periodicity value (Periodicity can be weekly, biweekly, monthly, quarterly, half-yearly, No-periodicity).

Final Series Prediction module 310: Refining the clusters and the corresponding periodicity estimates by incorporating other derived information like merchant, category and amount.

Details of each module are described below.

Data Normalization module 302: Initially, the transactions undergo normalization by eliminating special characters and substituting digits. Afterward, a synonym generator powered by data-driven deep learning is trained for each remaining word. All synonyms generated are subsequently substituted with a single word selected from the synonym list. This technique helps to minimize variation in the descriptions, facilitates clustering, and retains all pertinent information (for example, “dpt”, “depst”, “depost” are all synonyms of “deposit”). The output of this Data Normalization module 302 will be the normalized transactions.

Similarity Assessment module 304: The objective is to determine the resemblance between a pair of transactions. Assuming two given transactions, namely t1 and t2, the outcome will be a similarity score computed according to Equation 1, where, NCW=number of common words in the normalized description between t1 and t2, and where NDW=number of distinct words in the normalized description of t1 and t2.

$$sim ( t 1 , t 2 ) = \frac{NCW}{NDW} \qquad Equation 1$$

If the similarity score between two transactions (t1, t2) is greater than or equal to a certain threshold value (which, in one embodiment may be 0.6, or in another embodiment may be selected between the range of 0.35 to 0.78), then it is considered that there is a connection between those two transactions, with each transaction being represented as a node in a graph. For an individual with n transactions, the similarity score will be computed for ₂ⁿC pairs of transactions, and edges will be created between those pairs where the similarity score is greater than or equal to the threshold. As a result, at the end of this process, a large graph will be created for the individual, with some nodes connected to each other. The graphs illustrated in the Similarity Assessment module 304 is one such example of the output of the Similarity Assessment module 304.

In an embodiment, M months' worth of financial transactions is accessed for each individual, with M usually being 6 months or greater. However, the recurrence predictor 204 can function with a shorter period, but it may not be practical since identifying recurring transactions at a quarterly level necessitates at least 6 months of transaction data.

Graph Segmentation module 306: Once the graph has been obtained, the objective is to identify all the connected components present within the graph. To accomplish this, the Disjoint Set Unit (DSU) algorithm is utilized. As an illustration, upon obtaining the graph (as shown in Similarity Assessment module 304), the DSU algorithm is applied to yielded 4 connected components (as depicted by the bounding regions in Similarity Assessment module 304).

Each connected component will have a unique series identifier, which indicates each series (i.e. segment). The series will be subsequently partitioned based on dimension (e.g. category, merchant, and amount details in the example illustrated in Graph Segmentation module 306), using Hierarchical Clustering. This approach enables identification of similarities and dissimilarities at four different levels, thereby facilitating the creation of a homogeneous series.

Recurrence Pattern Identification module 308: Once the series identifiers have been obtained, the next step is to calculate the periodicity for each series (i.e., set of transactions included in the series). The periodicity is classified into one of the six intervals:
Weekly
Bi-weekly
Monthly
Quarterly
Half-yearly

No-periodicity (if none of the above periodicity values can be assigned with confidence).

To compute the periodicity of each series, the transactions are sorted based on the transaction date and the time gaps between dates are identified. This information is then used to estimate the periodicity of each series and calculate the associated probability.

This periodicity will be calculated for each of the hierarchical levels of each series, for example:
Transaction Description level
Transaction Description with category level
Transaction Description with category and merchant level
Transaction Description with category, merchant and amount level

Final Series Prediction module 310: Currently, multiple hierarchical levels of series are obtained along with their respective periodicity. However, periodicity corresponding to only one of these series is ultimately selected. To achieve this, a tree-based information gain system is utilized, where a tree is constructed and post-order traversal is employed to optimize the periodicity score. The series with the highest periodicity score is then designated as the final series, and its corresponding series identifier and periodicity are assigned to the transactions. Equation 2 illustrates an example of this process.

$$periodicity score ( {node}_{{c}_{j}} ) = max ( {periodicity}_{self} , \sum \# txns ( {c}_{{child}_{i}} ) * max ( {periodicity}_{{child}_{i}} ) ) \qquad Equation 2$$

Finally, the series identifier and the periodicity for each transaction is obtained and provided as the final output.

### SUMMARY

The recurrence predictor 204 is configured to predict recurrence in financial transaction data in an unsupervised manner, and thus differentiates between recurring and non-recurring transactions. There is no dependence on human labels for training the setup. This makes the approach generalizable to a wide variety of data sources.

Additionally, the embodiments described herein create different series in a hierarchical manner by adding more dimensions of the transactions incrementally.

Further, transactions of an individual are clustered using a graph-connected-components approach. This approach scales seamlessly when new transactions are added for an individual and/or when new individuals are added to the system and/or when individuals from different sources are added to the system.

The criteria for choosing the final periodicity value is an information-theoretic approach. The hierarchies mentioned above can lead to different periodicities with different confidences although each level builds on information from the previous levels. The level of hierarchy which leads to the highest information gain is chosen as the final output.

The embodiments described herein have numerous potential use cases, including: (a) forecasting future income and expenses, which is crucial in determining how much a user can spend to meet their financial requirements, and (b) creating financial products that allow relevant authorities to gain insights into the data, such as developing a product that solely focuses on payroll/salary transactions.

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, etc.

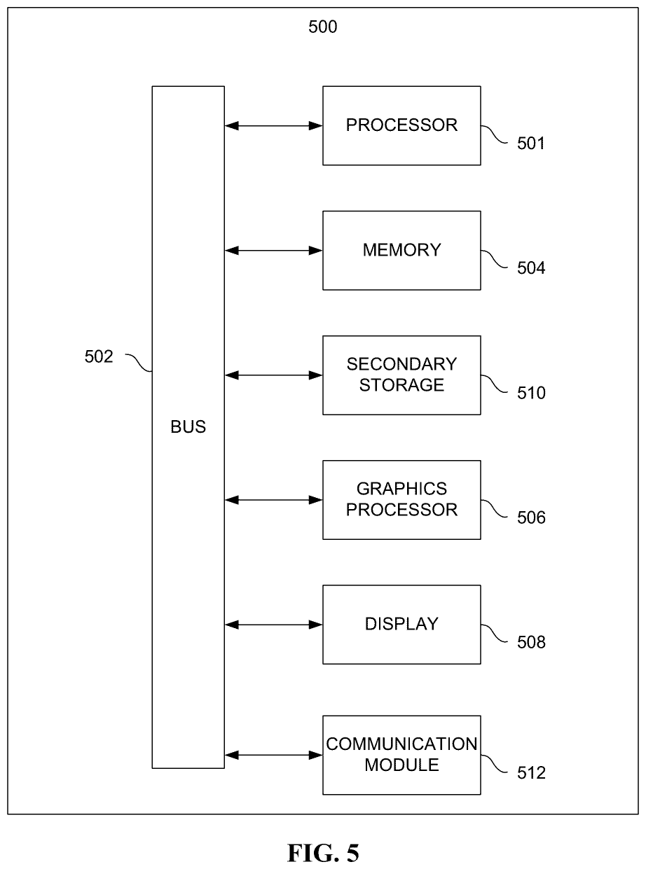

FIG. 5 illustrates an exemplary system 500, in accordance with one embodiment. As an option, the system 500 may be implemented in the context of any of the devices of the network architecture 500 of FIG. 5. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
access financial transaction data for an individual;
process the financial transaction data to detect one or more recurring financial transactions, wherein each of the recurring financial transactions is detected based on contextual information included in the financial transaction data; and
output the one or more recurring financial transactions.

2. The non-transitory computer-readable media of claim 1, wherein the financial transaction data includes historical financial transactions performed using at least one account of the individual with at least one financial institution.

3. The non-transitory computer-readable media of claim 2, wherein the historical financial transactions include withdrawals from the at least one account and deposits to the at least one account.

4. The non-transitory computer-readable media of claim 1, wherein the contextual information includes a transaction category.

5. The non-transitory computer-readable media of claim 1, wherein the contextual information includes a merchant.

6. The non-transitory computer-readable media of claim 1, wherein the one or more recurring financial transactions included a recurring withdrawal from the at least one account.

7. The non-transitory computer-readable media of claim 1, wherein the one or more recurring financial transactions included a recurring deposit to the at least one account.

8. The non-transitory computer-readable media of claim 1, wherein the financial transaction data is processed to detect the one or more recurring financial transactions by:
normalizing each historical financial transaction included in the financial transaction data.

9. The non-transitory computer-readable media of claim 8, wherein normalizing each historical financial transaction includes reducing a dimensionality of the historical financial transaction.

10. The non-transitory computer-readable media of claim 8, wherein the financial transaction data is processed to detect the one or more recurring financial transactions by:
quantifying a similarity between every unique pair of normalized historical financial transactions.

11. The non-transitory computer-readable media of claim 10, wherein the financial transaction data is processed to detect the one or more recurring financial transactions by:
creating a graph based on the similarity between every unique pair of normalized historical financial transactions,
wherein the normalized historical financial transactions are represented as nodes in the graph, and wherein an edge is created between nodes representing one of the unique pairs of normalized historical financial transactions when the similarity between the unique pair of normalized historical financial transactions is greater or equal to a predefined threshold.

12. The non-transitory computer-readable media of claim 11, wherein the financial transaction data is processed to detect the one or more recurring financial transactions by:
identifying each set of connected nodes in the graph as a respective series.

13. The non-transitory computer-readable media of claim 12, wherein the financial transaction data is processed to detect the one or more recurring financial transactions by:
partitioning each series hierarchically by dimension.

14. The non-transitory computer-readable media of claim 13, wherein the financial transaction data is processed to detect the one or more recurring financial transactions by:
computing a probabilistic periodicity value at each hierarchical level for each series, wherein the periodicity is selected from:
weekly,
biweekly,
monthly,
quarterly,
half-yearly, or
no-periodicity.

15. The non-transitory computer-readable media of claim 14, wherein the financial transaction data is processed to detect the one or more recurring financial transactions by:
optimizing a periodicity score per series based on the probabilistic periodicity value at each hierarchical level for the series,
determining one series with a highest periodicity score,
designating the one series as a final series,
assigning an identifier of the final series and a periodicity of the final series to transactions associated with the final series, such that the transactions associated with the final series are detected as at least a portion of the one or more recurring financial transactions.

16. The non-transitory computer-readable media of claim 15, wherein the periodicity score is optimized utilizing a tree-based information gain system, where a tree is constructed and post-order traversal is employed to optimize the periodicity score based on the probabilistic periodicity value at each hierarchical level for the series.

17. The non-transitory computer-readable media of claim 1, wherein the one or more recurring financial transactions are output for forecasting future income and expenses for the individual.

18. The non-transitory computer-readable media of claim 1, wherein the one or more recurring financial transactions are output in a report.

19. A method, comprising:
at a computer system:
accessing financial transaction data for an individual;
processing the financial transaction data to detect one or more recurring financial transactions, wherein each of the recurring financial transactions is detected based on contextual information included in the financial transaction data; and
outputting the one or more recurring financial transactions.

20. A system, comprising:
a non-transitory memory storing instructions; and
one or more processors in communication with the non-transitory memory that execute the instructions to:
access financial transaction data for an individual;
process the financial transaction data to detect one or more recurring financial transactions, wherein each of the recurring financial transactions is detected based on contextual information included in the financial transaction data; and
output the one or more recurring financial transactions.
